(19) United States
(12) Patent Application Publication
(10) Pub. No.: US 2014/0365932 A1
(43) Pub. Date: Dec. 11, 2014

(54) METHOD AND APPARATUS FOR DISPLAYING CHARACTER IN MOBILE DEVICE

(71) Applicant: Samsung Electronics Co., Ltd., Gyeonggi-do (KR)

(72) Inventor: Hyungsuk Hwang, Gyeonggi-do (KR)

(21) Appl. No.: 14/302,364

(22) Filed: Jun. 11, 2014

(30) Foreign Application Priority Data
Jun. 11, 2013 (KR) 10-2013-0066353

(51) Int. Cl. G06F 3/0488; G06F 3/0481

(52) U.S. Cl. CPC G06F 3/04886; G06F 3/0481
USPC 715/768; 715/773

(57) ABSTRACT

An apparatus for displaying characters in a mobile device includes a screen configured to display an input window containing a virtual keyboard and a message window, wherein the screen is configured to receive one or more characters through a virtual keyboard in the input window on a screen in a typing mode, and a controller configured to cause the screen to display the one or more characters in the input window, and a message window on the screen at a substantially same time by each character received. A method includes receiving one or more characters through a virtual keyboard in an input window on a screen in a typing mode, and displaying the one or more characters in the input window, and a message window on the screen at a substantially same time by each character received. Other embodiments are disclosed.

### CROSS-REFERENCE TO RELATED APPLICATION AND CLAIM OF PRIORITY

The present application is related to and claims the benefit under 35 U.S.C. §119(a) of a Korean patent application No. 10-2013-0066353 filed on Jun. 11, 2013 in the Korean Intellectual Property Office, the entire disclosure of which is hereby incorporated by reference.

### TECHNICAL FIELD

The present disclosure relates to displaying characters for a mobile device and, more particularly, to a method and apparatus for displaying characters on a virtual keypad in mobile devices.

### BACKGROUND

With related technologies advanced recently, a variety of mobile devices such as a smart phone and a tablet computer are increasingly popularized due to their high usability and good portability. Nowadays, most of such mobile devices have a touch screen that allows touch-based manipulations.

In case that character inputs are required, a touch screen offers a virtual keypad thereon. Inherently a virtual keypad has no physical boundary between adjacent keys thereof. Thus, a user can enter a character while usually seeing a virtual keypad rather than seeing a message window.

Watching a virtual keypad to select characters to type invites some difficulties in immediately checking a character inputted in and displayed on a message window of a touch screen. Therefore, a user sometimes stops inputting a character and watches a message window in order to check whether any typing error happens. Unfortunately, this causes inconveniences to a user.

### SUMMARY

An apparatus for displaying characters in a mobile device is provided. The apparatus includes a screen configured to display an input window containing a virtual keyboard and a message window, wherein the screen is configured to receive one or more characters through a virtual keyboard in the input window on a screen in a typing mode, and a controller configured to cause the screen to display the one or more characters in the input window, and a message window on the screen at a substantially same time by each character received.

In some embodiments, the display is configured to split the screen into the input window and the message window upon the typing mode being selected.

In some embodiments, the control unit is further configured to perform an error inspection for the inputted character when a division mark key is inputted, and if a typing error is found through the error inspection, to control the display unit to display an error alarm on the input window.

In some embodiments, the one or more characters are displayed in an overlapping manner on the virtual keypad contained in the input window.

In some embodiments, the one or more characters overlapped on virtual keyboard are partially transparent.

In some embodiments, the one or more characters on the input window are cleared away upon a break event while the one or more characters on the message window remain.

In some embodiments, the controller is further configured to perform an error inspection for the one or more characters upon the break event, and if a typing error is found through the error inspection, display an error alarm on the input window.

In some embodiments, the break event is receiving a division mark comprising at least one of a space key, an enter key, and a plurality of punctuation mark keys.

In some embodiments, the break event is that the one or more characters form one of a syllable and a word.

In some embodiments, the error alarm is one of a blink of characters with an error, a blink of the virtual keypad, changing a color of characters with an error, changing a color of the virtual keypad, and a combination thereof.

In some embodiments, the error alarm is disappeared when the typing error is corrected.

A method for displaying characters in a mobile device is provided. The method includes receiving one or more characters though a virtual keyboard in an input window on a screen in a typing mode, and displaying the one or more characters in the input window, and a message window on the screen at a substantially same time by each character received.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a mobile device in accordance with an embodiment of the present disclosure.

FIG. 2 is a flow diagram illustrating a process of displaying a character input on an input window as well as on a message window in a text typing mode in accordance with an embodiment of the present disclosure.

FIG. 3 illustrates a screen of a mobile device in a text typing mode in accordance with an embodiment of the present disclosure.

FIG. 4 is a flow diagram illustrating a process of displaying a character input on an input window by a predefined character unit for display in a mobile device in accordance with an embodiment of the present disclosure.

FIGS. 5A to 5C illustrate a process of displaying a character input on an input window by a predefined character unit for display in a mobile device in accordance with an embodiment of the present disclosure.

FIGS. 6A to 6C illustrate a process of displaying a detected typing error on an input window in a mobile device in accordance with an embodiment of the present disclosure.

### DETAILED DESCRIPTION

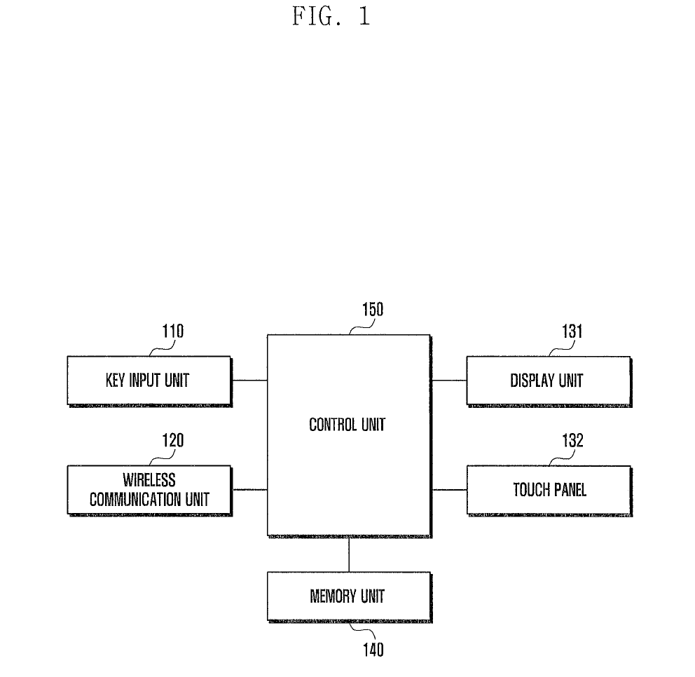

FIGS. 1 through 6C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a character” includes reference to one or more of such characters.

In the present disclosure, the term ‘a message window’ refers to a specific region provided on a screen of a display unit in order to display characters entered, and the term ‘an input window’ refers to another region provided on the screen in order to temporarily display a virtual keypad in a text typing mode.

Additionally, in this disclosure, the term ‘text’ refers to a character string displayed on the message window, and the term ‘a predefined character unit for display’ refers to a character or characters selectively displayed on the input window. Particularly, such a selected character can be displayed in an overlay form on the virtual keypad. In various embodiments, a predefined character unit for display can be based on a syllable, a word(or a word-phrase), or the like. Further, a predefined character unit for display can be recognized through a division mark key which can be selected from a space key, an enter key, or any punctuation mark key such as a period, comma, bracket, colon, or semicolon key.

FIG. 1 is a block diagram illustrating a mobile device in accordance with an embodiment of the present disclosure.

Referring to FIG. 1, the mobile device can include a key input unit 110, a wireless communication unit 120, a display unit 131, a touch panel 132, a memory unit 140, and a control unit 150. In some embodiments, the display unit 131 and the touch panel 132 can be unified to form a touch screen.

The key input unit 110 receives a user's key input for manipulating the mobile device. In case the mobile device supports a full touch screen, the key input unit 110 can have only minimum keys such as a power on/off key, a volume key, a cancel key, etc. normally provided on a lateral side of the mobile device. In some embodiments, the key input unit 110 can receive a key input for requesting the termination of a text typing mode. Also, the key input unit 110 can receive a specific key input (e.g., from a menu key) for displaying a menu page that contains a setting menu.

The wireless communication unit 120 performs a wireless communication function of the mobile device. The wireless communication unit 120 can include an RF (Radio Frequency) transmitter that up-converts the frequency of an outgoing signal and amplifies the signal, an RF receiver that amplifies with low-noise an incoming signal and down-converts the frequency of the signal, and the like. Further, the wireless communication unit 120 can include a mobile communication module such as an LTE module, a CDMA module, etc., a digital broadcast module such as a DMB module, a DVB module, etc., a wireless internet communication module such a WiFi module, a Wibro module, etc., and/or a short-range communication module such as a Bluetooth module, an NFC (Near Field Communication) module, etc.

The display unit 131 can be formed of LCD (Liquid Crystal Display), OLED (Organic Light Emitted Diode), AMOLED (Active Matrix OLED), a flexible display, a transparent display, or the like. The display unit 110 visually offers a user a variety of information such as a menu of the mobile device, any data inputted, created, stored or received, and function setting information. Especially, in a text typing mode (e.g., in a state where a text message, an email, or an instant messenger application is executed), the display unit 131 visually offers an input window and a message window to a user thereon. Additionally, the display unit 131 displays characters entered (i.e., inputted by a user) on both the input window and the message window. In this case, the display unit 131 can display such characters entered together with a virtual keypad in an overlay manner on the input window under the control of the control unit 150.

The touch panel 132 is a device for detecting user's touch inputs. The touch panel 132 can be formed of a capacitive overlay type, a resistive overlay type, or an infrared beam type. Additionally, any other type for detecting contact, pressure or approach of an object can be applied to the touch panel 132. Normally, the touch panel 132 detects the occurrence of a touch input together with the position of a touch point. In particular, the touch panel 132 detects a touch-based character input from the virtual keypad of the input window in a text typing mode. Also, the touch panel 132 detects any other touch input for setting a selected function from the virtual keypad of the input window.

The memory unit 140 stores a program required for the operation of the mobile device and related data. In embodiments, the memory unit 140 can store various applications for a character input, message transmission, and the like. Also, the memory unit 140 can store a specific application for supporting a display of a character on the input window in a text typing mode. This application can contain a command to detect a typing error from a character input and to display an error alarm in case any typing error is detected. And also, the memory unit 140 can store necessary image data for displaying a character on the input window, and data associated with an input action using the touch panel 131 or the key input unit 110.

The control unit 150 identifies an input event for requesting an entry into a text typing mode and then, in response to this event, controls an entry into a text typing mode. Additionally, depending on user's setting, the control unit 150 can control the display unit 131 to display or hide a character input on the input window in a text typing mode. Furthermore, the control unit 150 can control various tasks associated with normal functions of the mobile device.

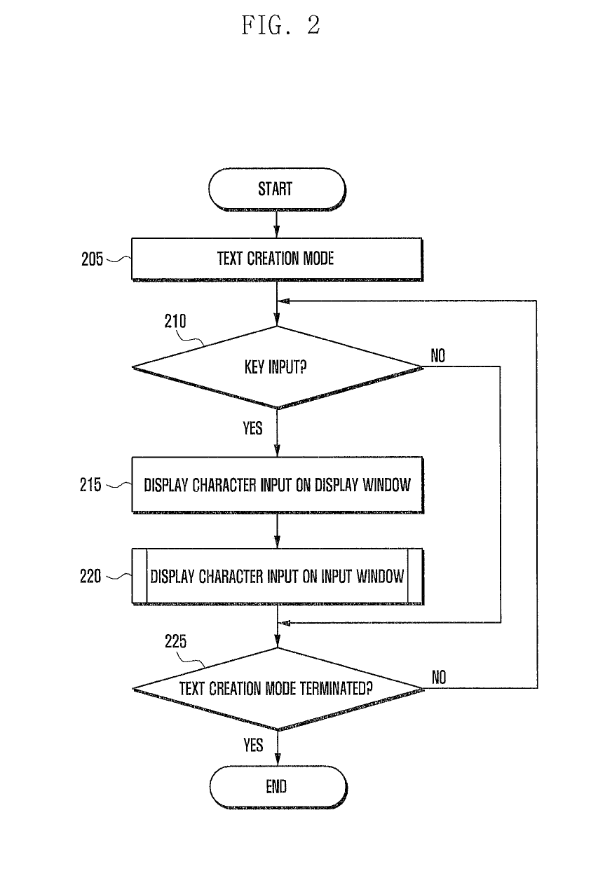

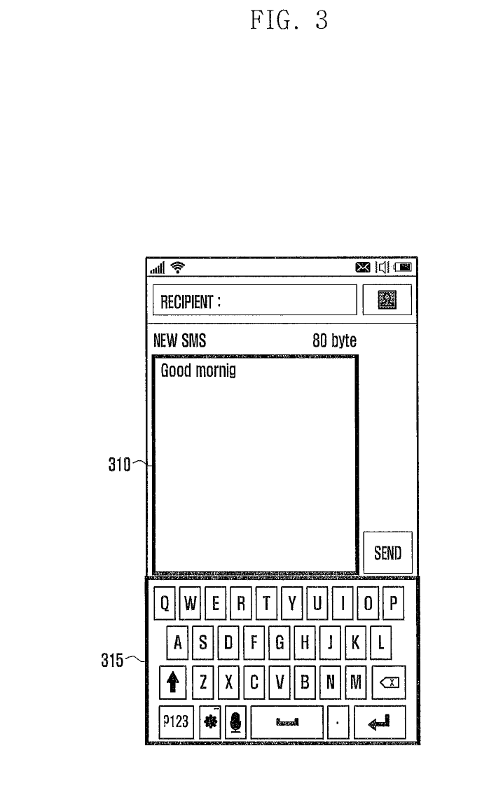

Now, a process of displaying a character input on the input window in a text typing mode will be described with reference to FIGS. 2 and 3.

FIG. 2 is a flow diagram illustrating a process of displaying a character input on an input window as well as on a message window in a text typing mode in accordance with an embodiment of the present disclosure. FIG. 3 is a screenshot illustrating a screen of a mobile device in a text typing mode in accordance with an embodiment of the present disclosure.

Referring to FIG. 2, at operation 205, the control unit 150 of the mobile device can enter into a text typing mode at a user's request. A text typing mode indicates a state where a text message application, an email application, an instant messenger application, or the like is executed while both a message window and an input window are displayed on the screen. Referring to FIG. 3 for more detailed description, a screen displayed on the display unit 131 in a text typing mode can contain a message window 310 and an input window 315. As shown in FIG. 3, the message window 310 can be disposed above the input window 315 on the screen, displaying an inputted character string such that a user can see the entire input content. The input window 315 displays a virtual keypad.

Once entering into a text typing mode at a user's request, the control unit 150 displays at operation 205 the message window 310 and the input window 315 as shown in FIG. 3. If a user inputs a character through a virtual keypad displayed on the input window 315, the control unit 150 can detect a character input received through the touch panel 132 at operation 210. To input a character can be performed by a user's touch input on the virtual keypad displayed on the input window 315.

Thereafter, at operation 215, the control unit 150 can display, on the message window 310, text composed of characters inputted. Namely, the control unit 150 displays on the message window 310 an accumulated character string, in the form of text, inputted through the virtual keypad. Together with displaying text on the message window 310 at operation 215, the control unit 150 can display a character input by a predefined character unit for display on the input window 315 at operation 220. Namely, the control unit 150 selectively displays a character or characters according to a predefined character unit for display on the input window 315, contrary to the message window 310. Namely, the control unit 150 displays all inputted characters in an accumulative form on the message window 310 in the order of inputs, and also selectively displays a part of such characters on the input window 315 by a predefined character unit (e.g., a letter, a syllable, a word, a word-phrase, etc.) for display. Herein, a predefined character unit for display can be set in advance.

Thereafter, at operation 225, the control unit 150 can determine whether a request for terminating a text typing mode is received through a user's key input or touch input. If no request for terminating a text typing mode is received, the control unit 150 can return to operation 210. In contrast, if there is such a request received at operation 225, the control unit 150 terminates a text typing mode and related process.

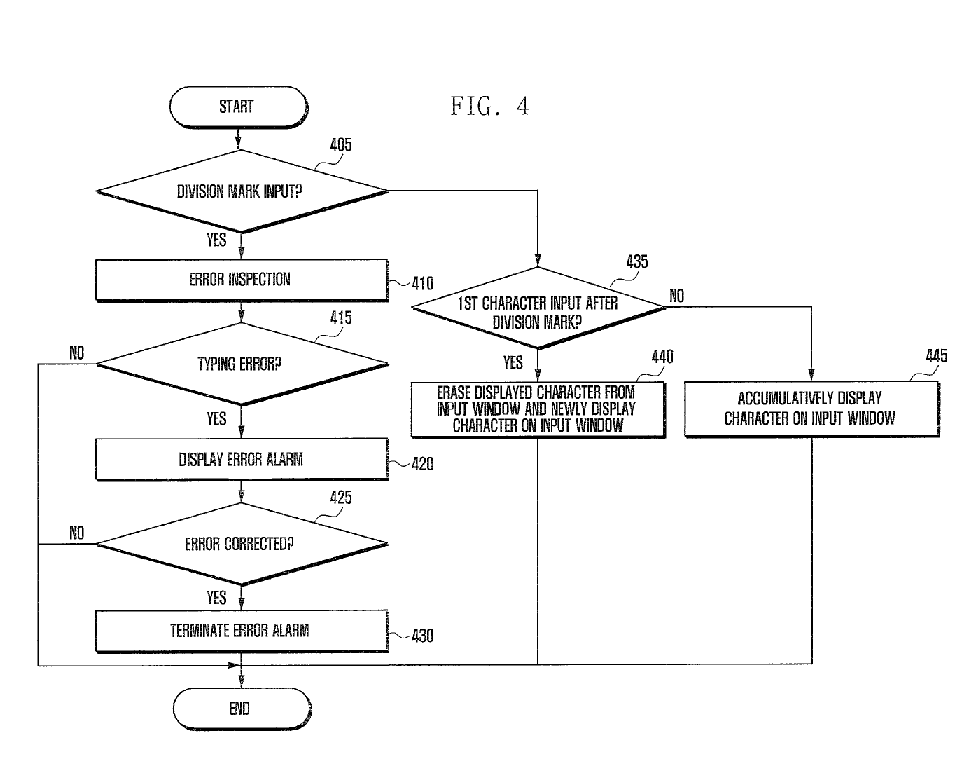

Now, operation 220 in FIG. 2 will be described in detail with reference to FIGS. 4 to 6.

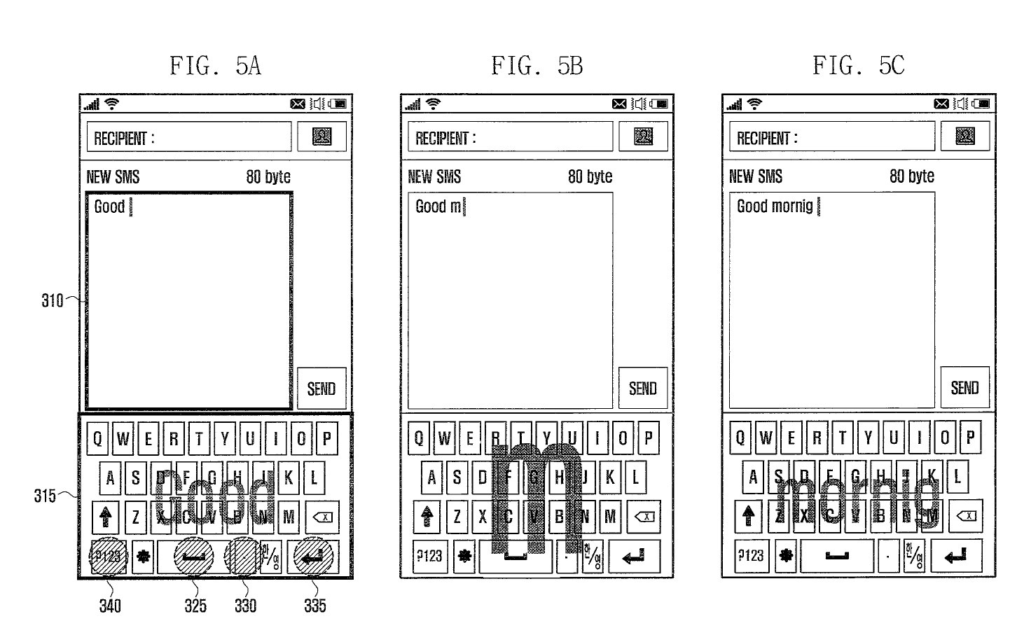

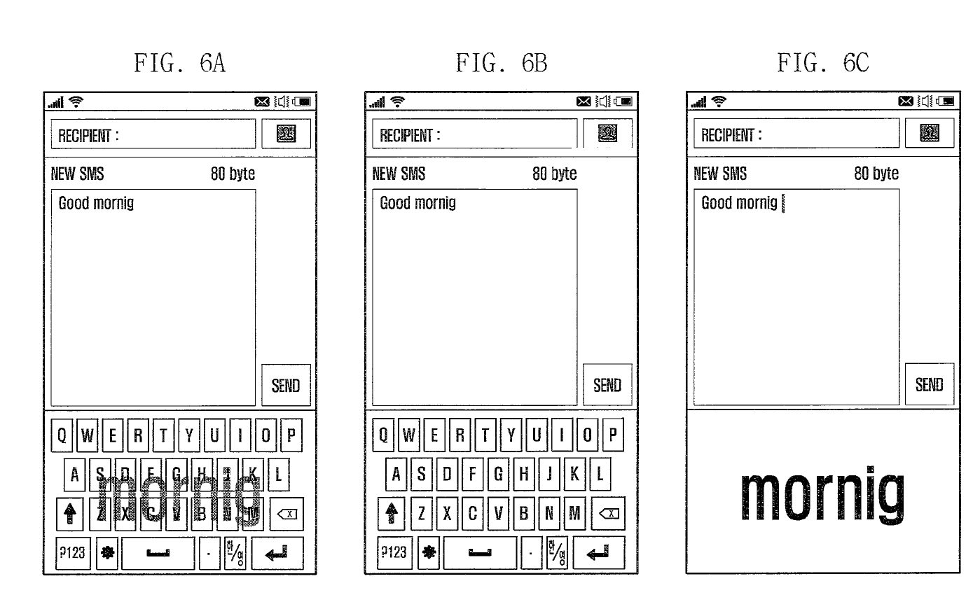

FIG. 4 is a flow diagram illustrating a process of displaying a character input on an input window by a predefined character unit for display in a mobile device in accordance with an embodiment of the present disclosure. FIG. 4 shows a detailed process of operation 220 in FIG. 2. FIGS. 5A to 5C are screenshots illustrating a process of displaying a character input on an input window by a predefined character unit for display in a mobile device in accordance with an embodiment of the present disclosure. FIGS. 6A to 6C are screenshots illustrating a process of displaying a detected typing error on an input window in a mobile device in accordance with an embodiment of the present disclosure. FIGS. 4 to 6 show an example of English input.

Referring first to FIG. 4, at operation 405, the control unit 150 determines whether a division mark key is inputted. Here, a division mark key can be a space key, an enter key, or any punctuation mark key such as a period, comma, bracket, colon, or semicolon key. If an input of a division mark is detected at operation 405, the control unit 150 performs an error inspection at operation 410. For example, the control unit 150 recognizes characters prior to a division mark as one word and determines the target of an error inspection from the recognized word. Then, at operation 415, the control unit 150 can check whether any typing error is detected. If there is any typing error, the control unit 150 can output an error alarm at operation 420. This error alarm can be, for example, a graphical effect provided on the input window 315 such that a user can easily perceive the occurrence of a typing error. After an error alarm is outputted, the control unit 150 can determine at operation 425 whether the detected typing error is corrected by a user. This correction can include the replacement of a current character string by another character string, the deletion of a current character string, the insertion of an additional character after the movement of a cursor in the message window 310, and the like. If such a correction is completed, the control unit 150 can terminate an error alarm at operation 430. Then the process shown in FIG. 4 is ended.

Meanwhile, if an input of a division mark is not detected at operation 405, the control unit 150 determines at operation 435 whether a currently inputted character is the first character following a division mark key. If so, the control unit 150 can erase a previously displayed character from the input window 315 at operation 440 and also control the input window 315 to newly display the currently inputted character thereon. However, if a currently inputted character is not the first character following a division mark key, the control unit 150 can control at operation 445 the input window 315 to display thereon the currently inputted character in addition to a previously displayed character without erasing the previously displayed character. Namely, characters are accumulatively displayed on the input window 315. After operation 440 or 445, the process shown in FIG. 4 is ended.

Now, the process discussed in FIG. 4 will be described in detail with reference to FIGS. 5A to 5C which show screenshots in case of English input.

Referring first to FIG. 5A, in a text typing mode, the control unit 150 can control the display unit 131 to display an inputted character on both the message window 310 and the input window 315. Particularly, in case of the input window 315, a character is displayed in an overlay form on a virtual keypad under the control of the control unit 150. To distinguish the displayed character from the virtual keypad, the control unit 150 can adjust the color and/or transparency of the displayed character and/or the virtual keypad.

FIG. 5A shows a word of ‘Good’ that is entered through the virtual keyboard in the input window 315 and displayed on the message window 310. When a word e.g., ‘Good’ is displayed on the message window 310, the same word is also displayed in an overlapping manner on the virtual keyboard in the input window 315. Although not shown in the drawing, ‘Good’ is entered one by one character on the message window 310 in the order of inputs, namely, ‘G’, ‘Go’, ‘Goo’, and ‘Good’. Likewise, the same characters as those displayed on the message window 310 are also displayed on the virtual keyboard in the input window 315 in the order of inputs. In some embodiments, the characters overlapped on the virtual keyboard are partially transparent, so as not to hide the keys on the virtual keyboard.

The control unit 150 detects whether a space key 325 is entered as a division mark key at operation 405, and checks whether there is a typing error at operation 415. As mentioned above, a division mark key can be a period key 330, an enter key 335, a symbol key 340, or any other specific key instead of the space key 325.

FIG. 5B shows a screen where a character ‘m’ is inputted after a division mark key is inputted in a state where a certain word ‘Good’ has been displayed on the message window 310. In this case, the control unit 150 recognizes at operation 435 that a currently inputted character ‘m’ is the first character following a division mark key. Then, at operation 440, the control unit 150 can erase a previously displayed word ‘Good’ from the input window 315 and also control the input window 315 to newly display the currently inputted character ‘m’ thereon. Namely, in case a division mark key is inputted, the message window 310 can display the entire inputted character string ‘Good m’, whereas the input window 315 can display only a character ‘m’ inputted after the division mark key. In case of English input, a character unit for display can be a word that is a spacing unit. Therefore, when the space key 325 is inputted after a character string ‘Good’ is inputted, the control unit 150 recognizes the character string ‘Good’ as one word to be used as a spacing unit. Then if a certain character following the division mark key is inputted, the control unit 150 controls the input window 315 to display only such a character. In this case, a character ‘m’ only that follows the division mark key is displayed on the input window 315.

Referring to FIG. 5C, it is assumed that a user mistakenly inputs a character string of ‘Good mornig’, instead of ‘Good morning’, the message window 310 and the input window 315 display ‘Good’ at a first time and upon a following space, the input window 315 clears ‘Good’ while message window 315 keeps displaying ‘Good’. Then the user types ‘mornig’, the message window 315 display ‘Good mornig’ and the input window displays only ‘morning’.

Namely, as discussed above, the control unit 150 controls the input window 315 to accumulatively display characters following a previous division mark key until the next division mark key is inputted. Therefore, in this case, the message window 310 displays ‘Good mornig’, whereas the input window 315 displays ‘mornig’ that are inputted after a previous division mark key.

The font size of a character displayed on the input window 315 can depend on the number of such characters. For example, FIG. 5A shows four characters ‘Good’ displayed on the input window 315, and FIG. 5B shows one character ‘m’ displayed on the input window 315. Therefore, a font size in case of FIG. 5B can be greater than that in case of FIG. 5A. Namely, when controlling the input window 315 to display a character at operations 440 and 445, the control unit 150 can adjust a font size of a character according to the number of characters to be displayed.

Additionally, the control unit 150 can control the input window 315 to display a character only between a previous division mark key and a cursor displayed on the message window 310. For example, if a cursor is located after a character ‘m’ following a division mark key, the control unit 150 can output a character ‘m’ only to the input window 315 as shown in FIG. 5B. Although not shown, in case a user moves back a cursor so as to modify a character previously inputted, namely in case a cursor is located at any position within a character string displayed on the message window 310, the input window 315 can display a character or characters only disposed between a division mark key and a cursor. For example, when a cursor is located after ‘Go’ within ‘Good’ while the message window 310 displays ‘Good’, the input window 315 can display only ‘Go’ rather than ‘Good’.

Additionally, in case a certain word has too many characters to be displayed in a single line on the input window 315, the control unit 150 can control the input window 315 to arrange such characters in two or more lines. In this case, the control unit 150 can further offer a scroll function to the input window 315.

Whenever a division mark key is inputted, the control unit 150 detects it at operation 405 and performs an error inspection for inputted characters (e.g., a word) at operation 410. FIG. 6A shows an example case where the message window 310 displays ‘Good mornig’ and the input window 315 displays ‘mornig’. Since a character unit for display is a word that is a spacing unit in case of English input, the input window 315 displays ‘mornig’ rather than ‘g’ or ‘Good mornig’. If a user inputs a division mark key such as a space key or question mark key after inputting ‘mornig’, the control unit 150 recognizes ‘mornig’ as one word at operation 405 and then performs an error inspection at operation 410. Normally this error inspection can be performed using a dictionary. Namely, any word that is not contained in a dictionary can be determined as a typing error. Further, a certain word composed of capital letters or beginning with a capital letter may be not considered as a typing error. Specifically, an acronym (e.g., USA, EU, LTE, etc.), a special word (e.g., Facebook, Bluetooth, Twitter, Google, etc.), and a proper noun such as a person's name or a name of a place (e.g., John, Merry, Seoul, Busan, etc.) may be considered as exceptional word rather than a typing error.

In case ‘mornig’ is inputted as shown in FIG. 6A, the control unit 150 determines it as a typing error at operation 415. In this case, ‘mornig’ may be a typing error of ‘morning’. Then the control unit 150 outputs an error alarm at operation 420. One example of an error alarm is a blink of characters displayed on the input window 315. Namely, screens shown in FIGS. 6A and 6B are displayed alternately. Another example is a blink of a virtual keypad displayed on the input window 315. Namely, screens shown in FIGS. 6A and 6C are displayed alternately. Besides, a change in color of characters displayed on the input window 315, a blink of color-changed characters, a change in color of a virtual keypad, or the like can be used for an error alarm.

Additionally, the control unit 150 can control the input window 315 to display a real-time error correction. Namely, when a correction (e.g., the deletion or addition of a character, a change in position of a cursor, etc.) of a typing error is detected at operation 425, the control unit 150 controls at operation 430 the message window 310 to display the entire character string including a corrected word and also controls the input window 315 to display a corrected word. In this case, a corrected word can be a character or characters disposed before a cursor. Namely, when a cursor is located at any position within a character string displayed on the message window 310, the input window 315 displays a character or characters only disposed between the cursor and a division mark key disposed before the character string in which the cursor is located. For example, when a cursor is located between ‘i’ and ‘g’ within ‘Good mornig’ displayed on the message window 310, the input window 315 displays ‘morni’ thereon under the control of the control unit 150. If a character ‘n’ is then inputted through a virtual keypad, the input window 315 displays ‘mornin’ thereon under the control of the control unit 150. Also, the message window 310 further displays an inputted character ‘n’ thereon, and a cursor is located between ‘n’ and ‘g’.

Thereafter, if a user moves a cursor, the control unit 150 recognizes it as an input of a division mark key at operation 405 and, based on a new position of the cursor, performs again an error inspection at operation 410. Namely, in response to an input of another division mark key after an error correction, the control unit 150 performs again an error inspection. As discussed in FIG. 4, in case any detected typing error is corrected, the control unit 150 terminates an error alarm. However, even in case a division mark key and the following character are inputted in sequence, the control unit 150 terminates an error alarm. Namely, the control unit 150 can consider that an additional character input after an input of a division mark is an action for accepting a typing error.

As fully discussed hereinbefore, a touch-sensitive mobile device can display a character input on a virtual keypad as well as a message window. Thus, a user can input a character while seeing only the virtual keypad without the need to see the message window. Further, in case any typing error happens, a user can easily find such an error through an error alarm.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for displaying characters in a mobile device, the method comprising:
receiving one or more characters through a virtual keyboard in an input window on a screen in a typing mode; and
displaying the one or more characters in the input window, and a message window on the screen at a substantially same time by each character received.

2. The method of claim 1, further comprising:
splitting the screen into the input window and the message window upon the typing mode being selected.

3. The method of claim 1, wherein the one or more characters are displayed in an overlapping manner on the virtual keypad contained in the input window.

4. The method of claim 1, wherein the one or more characters overlapped on virtual keyboard are partially transparent.

5. The method of claim 1, the one or more characters on the input window are cleared away upon a break event while the one or more characters on the message window remain.

6. The method of claim 5, further comprising:
performing an error inspection for the one or more characters upon the break event; and
if a typing error is found through the error inspection, displaying an error alarm on the in put window.

7. The method of claim 5, wherein the break event is receiving a division mark comprising at least one of a space key, an enter key, and a plurality of punctuation mark keys.

8. The method of claim 1, wherein the break event is that the one or more characters form one of a syllable and a word.

9. The method of claim 6, wherein the error alarm is one of a blink of characters with an error, a blink of the virtual keypad, changing a color of characters with an error, changing a color of the virtual keypad, and a combination thereof.

10. The method of claim 7, wherein the error alarm is disappeared when the typing error is corrected.

11. An apparatus for displaying characters input in a mobile device, the apparatus comprising:
a screen configured to display an input window containing a virtual keyboard and a message window, wherein the screen is configured to receive one or more characters through a virtual keyboard in the input window on a screen in a typing mode; and
a controller configured to cause the screen to display the one or more characters on the input window, and a message window on the screen at a substantially same time by each character received.

12. The apparatus of claim 11, wherein the display is configured to split the screen into the input window and the message window upon the typing mode being selected.

13. The apparatus of claim 11, wherein the control unit is further configured to perform an error inspection for the inputted character when a division mark key is inputted, and if a typing error is found through the error inspection, to control the display unit to display an error alarm on the input window.

14. The apparatus of claim 11, wherein the one or more characters are displayed in an overlapping manner on the virtual keypad contained in the input window.

15. The apparatus of claim 11, wherein the one or more characters overlapped on virtual keyboard are partially transparent.

16. The apparatus of claim 11, wherein the one or more characters on the input window are cleared away upon a break event while the one or more characters on the message window remain.

17. The apparatus of claim 16, wherein the controller is further configured to:
perform an error inspection for the one or more characters upon the break event; and
if a typing error is found through the error inspection, display an error alarm on the input window.

18. The apparatus of claim 16, wherein the break event is receiving a division mark comprising at least one of a space key, an enter key, and a plurality of punctuation mark keys.

19. The apparatus of claim 11, wherein the break event is that the one or more characters form one of a syllable and a word.

20. The apparatus of claim 17, wherein the error alarm is one of a blink of characters with an error, a blink of the virtual keypad, changing a color of characters with an error, changing a color of the virtual keypad, and a combination thereof.

21. The apparatus of claim 18, wherein the error alarm is disappeared when the typing error is corrected.
